(19) United States
(12) Patent Application Publication
(10) Pub. No.: US 2026/0044909 A1
(43) Pub. Date: Feb. 12, 2026

(54) ACCOMMODATION SUPPORT APPARATUS, SYSTEM, AND METHOD, AND COMPUTER-READABLE MEDIUM

(71) Applicant: NEC Corporation, Minato-ku, Tokyo (JP)

(72) Inventors: Takeyoshi OE, Tokyo (JP); Fumiya IGARASHI, Tokyo (JP); Haruka SATO, Tokyo (JP); Yusuke MIYAMOTO, Tokyo (JP); Saki KATO, Tokyo (JP); Yosuke TASHIRO, Tokyo (JP); Rin SATO, Tokyo (JP)

(73) Assignee: NEC Corporation, Minato-ku, Tokyo (JP)

(21) Appl. No.: 19/100,677

(22) PCT Filed: Sep. 8, 2022
(86) PCT No.: PCT/JP2022/033659

§ 371 Date: Feb. 3, 2025

(51) Int. Cl. G06Q 50/12; G06Q 10/02; G07C 9/27

(52) U.S. Cl. CPC G06Q 50/12; G06Q 10/02; G07C 9/27

(57) ABSTRACT

An accommodation support apparatus according to the present disclosure includes: at least one memory configured to store instructions; and at least one processor configured to execute the instructions to: specify reservation information of a user by identity authentication of the user in an accommodation facility; perform check-in processing for the user based on the reservation information; register a card ID recorded in a card key, used to unlock a room where the user completing the check-in processing stays and service information regarding a service included in the reservation information in association with each other; and perform processing according to the service information associated with the card ID if a request including the card ID read from the card key is acquired.

### TECHNICAL FIELD

The present disclosure relates to accommodation support apparatus, system, method, and program.

### BACKGROUND ART

In recent years, a biometric authentication technology including face authentication has been developed, and various services including payment using the biometric authentication technology have been introduced. Patent Literature 1 discloses a technology for allowing a guest who has applied for a meal in an accommodation facility to enter a restaurant by face authentication.

### CITATION LIST

### Patent Literature

Patent Literature 1: Japanese Unexamined Patent Application Publication No. 2022-001988

### SUMMARY OF INVENTION

### Technical Problem

Here, if a meal ticket is given as a paper ticket to the guest who has applied for a meal during a stay, the paper ticket is separated from a room key, and thus is likely to be lost. Further, there is still a need for unifying physical card keys as well as allowing the face authentication in all the services in using various services in the accommodation facility.

In view of the aforementioned problems, an object of the present disclosure is to provide accommodation support apparatus, system, method, and program for providing an optimal use environment for guests in consideration of various use needs.

### Solution to Problem

An accommodation support apparatus according to the present disclosure includes:
a specification means for specifying reservation information of a user by identity authentication of the user in an accommodation facility;
a check-in means for performing check-in processing for the user based on the reservation information;
a registration means for registering a card ID recorded in a card key, used to unlock a room where the user completing the check-in processing stays and service information regarding a service included in the reservation information in association with each other; and
a service processing means for performing processing according to the service information associated with the card ID if a request including the card ID read from the card key is acquired.

An accommodation support system according to the present disclosure includes:
an authentication terminal installed in an accommodation facility; and
an accommodation support apparatus,
the accommodation support apparatus including:
a specification means for specifying reservation information of a user by identity authentication of the user using the authentication terminal in the accommodation facility;
a check-in means for performing check-in processing for the user based on the reservation information;
a registration means for registering a card ID recorded in a card key, used to unlock a room where the user completing the check-in processing stays and service information regarding a service included in the reservation information in association with each other; and
a service processing means for performing processing according to the service information associated with the card ID if a request including the card ID read from the card key is acquired.

In an accommodation support method according to the present disclosure, a computer
specifies reservation information of a user by identity authentication of the user in an accommodation facility,
performs check-in processing for the user based on the reservation information,
registers a card ID recorded in a card key, used to unlock a room where the user completing the check-in processing stays and service information regarding a service included in the reservation information in association with each other, and
performs processing according to the service information associated with the card ID if a request including the card ID read from the card key is acquired.

An accommodation support program according to the present disclosure causes a computer to execute:
specification processing of specifying reservation information of a user by identity authentication of the user in an accommodation facility;
check-in processing for the user based on the reservation information;
registration processing of registering a card ID recorded in a card key, used to unlock a room where the user completing the check-in processing stays and service information regarding a service included in the reservation information in association with each other; and
service processing of performing processing according to the service information associated with the card ID if a request including the card ID read from the card key is acquired.

### Advantageous Effects of Invention

According to the present disclosure, it is possible to provide the accommodation support apparatus, system, method, and program for providing the optimal use environment for guests in consideration of the various use needs.

### BRIEF DESCRIPTION OF DRAWINGS

FIG. 1 is a block diagram illustrating a configuration of an accommodation support apparatus according to a first example embodiment.

FIG. 2 is a flowchart illustrating a flow of an accommodation support method according to the first example embodiment.

FIG. 3 is a block diagram illustrating a configuration of an accommodation support system according to a second example embodiment.

FIG. 4 is a block diagram illustrating a configuration of an authentication apparatus according to the second example embodiment.

FIG. 5 is a block diagram illustrating a configuration of an accommodation support apparatus according to the second example embodiment.

FIG. 6 is a flowchart illustrating a flow of reservation processing according to the second example embodiment.

FIG. 7 is a flowchart illustrating a flow of face information registration processing performed by the authentication apparatus according to the second example embodiment.

FIG. 8 is a sequence diagram illustrating a flow of check-in processing according to the second example embodiment.

FIG. 9 is a flowchart illustrating a flow of face authentication processing performed by the authentication apparatus according to the second example embodiment.

FIG. 10 is a view illustrating a display example of a card key issuance support screen according to the second example embodiment.

FIG. 11 is a view illustrating a display example of a registered content display screen according to the second example embodiment.

FIG. 12 is a sequence diagram illustrating a flow of service provision processing according to Example 2-1 of the second example embodiment.

FIG. 13 is a view illustrating a display example of a meal ticket confirmation screen according to Example 2-1 of the second example embodiment.

FIG. 14 is a sequence diagram illustrating a flow of service provision processing according to Example 2-2 of the second example embodiment.

FIG. 15 is a sequence diagram illustrating a flow of service provision processing according to Example 2-3 of the second example embodiment.

FIG. 16 is a diagram illustrating a display example of a meal ticket confirmation screen according to Examples 2-1 to 2-3 of the second example embodiment.

FIG. 17 is a sequence diagram illustrating a flow of processing of referring to registration information of a card key according to a third example embodiment.

FIG. 18 is a view illustrating a display example of a registered content display screen according to the third example embodiment.

### EXAMPLE EMBODIMENT

Hereinafter, example embodiments of the present disclosure will be described in detail with reference to the drawings. In the drawings, the same or corresponding elements are denoted by the same reference signs, and repeated description of the elements will be omitted to clarify the description as necessary.

### First Example Embodiment

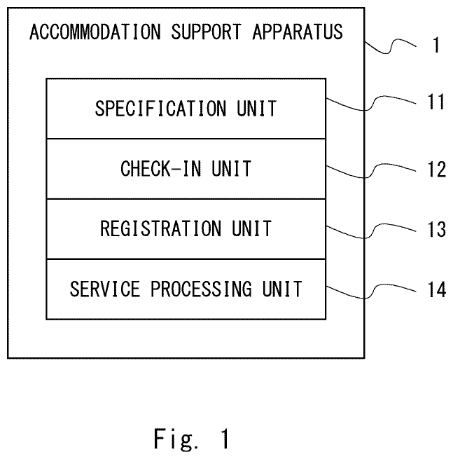

FIG. 1 is a block diagram illustrating a configuration of an accommodation support apparatus 1 according to a first example embodiment. The accommodation support apparatus 1 is an information processing apparatus that assigns service information such as a meal ticket together with a room unlocking function to a card key lent to a user who is a person reserving accommodations and checking in at an accommodation facility. The accommodation support apparatus 1 includes a specification unit 11, a check-in unit 12, a registration unit 13, and a service processing unit 14.

In the accommodation facility, the specification unit 11 specifies reservation information of the user by identity authentication of the user. Here, the “identity authentication” is information processing of confirming authenticity of an individual by collating identity authentication information registered in advance with information acquired from the individual or input from the individual at the time of the authentication and determining that a degree of matching is equal to or greater than a threshold value. Examples of the identity authentication include, but are not limited to, biometric authentication such as face authentication and collation of code information (such as an ID or a password) presented or input by the individual. In addition, the identity authentication processing is performed by internal processing of the accommodation support apparatus 1 or by an authentication apparatus connected to the accommodation support apparatus 1. In addition, it is assumed that the “identity authentication information” is registered in either a storage device inside the accommodation support apparatus 1 or a storage device connected to the accommodation support apparatus 1. In addition, it is assumed that the reservation information of the user is associated with the identity authentication information in the storage device, or is associated with identification information of the reserving person corresponding to the identity authentication information in another storage device that can be referred to by the accommodation support apparatus 1.

The check-in unit 12 performs check-in processing for the user based on the reservation information specified by the specification unit 11. Specifically, the check-in unit 12 confirms the specified reservation information and registers the confirmed reservation information in a database (not illustrated) that manages accommodation information. It is assumed that the database is stored in either a storage device inside the accommodation support apparatus 1 or a storage device connected to the accommodation support apparatus 1.

The registration unit 13 registers a card ID recorded in the card key used to unlock the room where the user completing the check-in processing stays and the service information regarding a service included in the reservation information in association with each other. As a premise, the registration unit 13 registers the card ID and a room number in association with each other. Further, the registration unit 13 according to the present example embodiment registers the card ID and the service information in the aforementioned database in association with each other.

Here, the “card key” is a physical card in which the card ID is recorded in a magnetic tape, an integrated circuit (IC) chip, or the like. Note that the shape of the “card key” is not necessarily a card type. The card ID in the card key of the magnetic tape is read by a magnetic card reader. In addition, the card ID in the “card key” incorporating the IC chip is read by a contact type or non-contact type card reader. Note that, in addition to the card ID, the room number, the service information, user information, the accommodation information, and the like may be recorded in the card key. Therefore, the registration unit 13 may register the service information and the like in the card key.

In addition, the “service” is a service that the user has applied for at the time of making a reservation, or a service included in the accommodation information, among services provided in the accommodation facility. Examples of the services provided in the accommodation facility include, but are not limited to, provision of food and drink (food and drink service) in a dining room, entry to a common space such as a dining room or a public bath, use of a massage machine, and purchase in a vending machine. In addition, the “service information” is information used to receive provision of the service, and examples thereof include permission to enter a dining room, a reservation for dinner or breakfast, an available time zone or meal content (a course menu or an optional menu), a table of a dining room, a gender of a user, distinction between an adult and a child, and an accommodation period. However, the service information is not limited thereto.

Then, the card key is lent to the checked-in user during the accommodation period. The user taps the lent card key on an authentication terminal for controlling locking of a door of the room where the user stays. The authentication terminal reads a card ID from the card key, collates the read card ID with a card ID associated with the room number, and unlocks the door if the both match. Note that a valid flag that is valid only during the accommodation period of the checked-in user (or an invalid flag outside the accommodation period), the accommodation period, and an available period of the card key may be recorded in the card key. In this case, the authentication terminal does not unlock the door if the valid flag is not recorded in the tapped card key, the invalid flag is recorded in the card key, the accommodation period has expired, and the recorded available period has expired.

If a request including a card ID read from the card key is acquired, the service processing unit 14 performs processing according to service information associated with the card ID. First, the user taps the lent card key on a predetermined authentication terminal in the accommodation facility. The predetermined authentication terminal reads the card ID from the card key, and transmits the request including the read card ID to the service processing unit 14. Here, the “predetermined authentication terminal” includes a service terminal installed in the accommodation facility, a check-in terminal, an authentication terminal that controls control of a door of a room, or a user terminal carried by the checked-in user in the accommodation facility.

In addition, examples of the “processing according to service information” include the following processing. However, the processing is not limited thereto.
(1) Processing in which the service processing unit 14 refers to the database, specifies service information associated with the card ID included in the request, and returns the specified service information to the authentication terminal of a request source.
(2) Processing of determining whether or not a service is available based on the service information specified in (1) and returning a determination result to the authentication terminal of the request source
(3) Processing of returning the specified service information and the determination result to the authentication terminal of the request source if the determination result of (2) indicates availability.
(4) Processing of performing service provision processing according to the determination result of (2) and returning a processing result to the authentication terminal of the request source

Here, examples of the “service provision processing” include, but are not limited to, table guidance in a dining room, order processing according to a menu or a course, and a meal provision instruction.

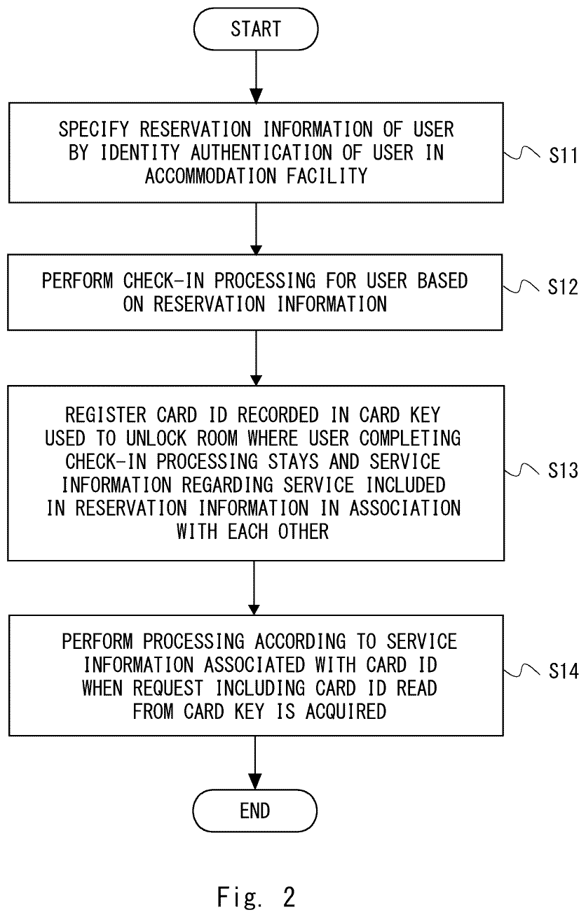

FIG. 2 is a flowchart illustrating a flow of an accommodation support method according to the first example embodiment. First, the specification unit 11 specifies reservation information of a user by identity authentication of the user in an accommodation facility (S11). Next, the check-in unit 12 performs check-in processing for the user based on the reservation information (S12). Then, the registration unit 13 registers a card ID recorded in a card key used to unlock a room where the user completing the check-in processing stays and service information regarding a service included in the reservation information in association with each other (S13). Thereafter, if a request including the card ID read from the card key is acquired, the service processing unit 14 performs processing according to the service information associated with the card ID (S14).

As described above, in the present example embodiment, the service information such as a meal ticket is assigned to the card key used to unlock the room together with an unlocking function of the room, so that the user can also receive provision of services using the card key for entering the room. That is, the user can not only enter the room using one card key lent during an accommodation period but also receive provision of various services. Therefore, it is possible to provide an optimal use environment for a guest in consideration of various use needs.

Note that the accommodation support apparatus 1 includes a processor, a memory, and a storage device as components (not illustrated). In addition, the storage device stores a computer program in which processing of the accommodation support method according to the present example embodiment is implemented. Then, the processor reads a computer program or the like from the storage device into the memory and executes the computer program. As a result, the processor implements the functions of the specification unit 11, the check-in unit 12, the registration unit 13, and the service processing unit 14.

Alternatively, each component of the accommodation support apparatus 1 may be implemented by dedicated hardware. In addition, some or all of the components of each apparatus may be implemented by general-purpose or dedicated circuitry, a processor, or a combination thereof. These constituent elements may be configured with a single chip or may be configured with a plurality of chips connected via a bus. Some or all of the components of each apparatus may be implemented by a combination of the aforementioned circuitry or the like and a program. In addition, as the processor, a central processing unit (CPU), a graphics processing unit (GPU), a field-programmable gate array (FPGA), a quantum processor (quantum computer control chip), or the like can be used.

In addition, in a case where some or all of the components of the accommodation support apparatus 1 are implemented by a plurality of information processing apparatuses, circuits, and the like, the plurality of information processing apparatuses, circuits, and the like may be arranged in a centralized manner or in a distributed manner. For example, the information processing apparatuses, the circuits, or the like may be implemented in the form of a client server system, a cloud computing system, or the like in which they are connected to each other via a communication network. In addition, the function of the accommodation support apparatus 1 may be provided in a software as a service (SaaS) format.

### Second Example Embodiment

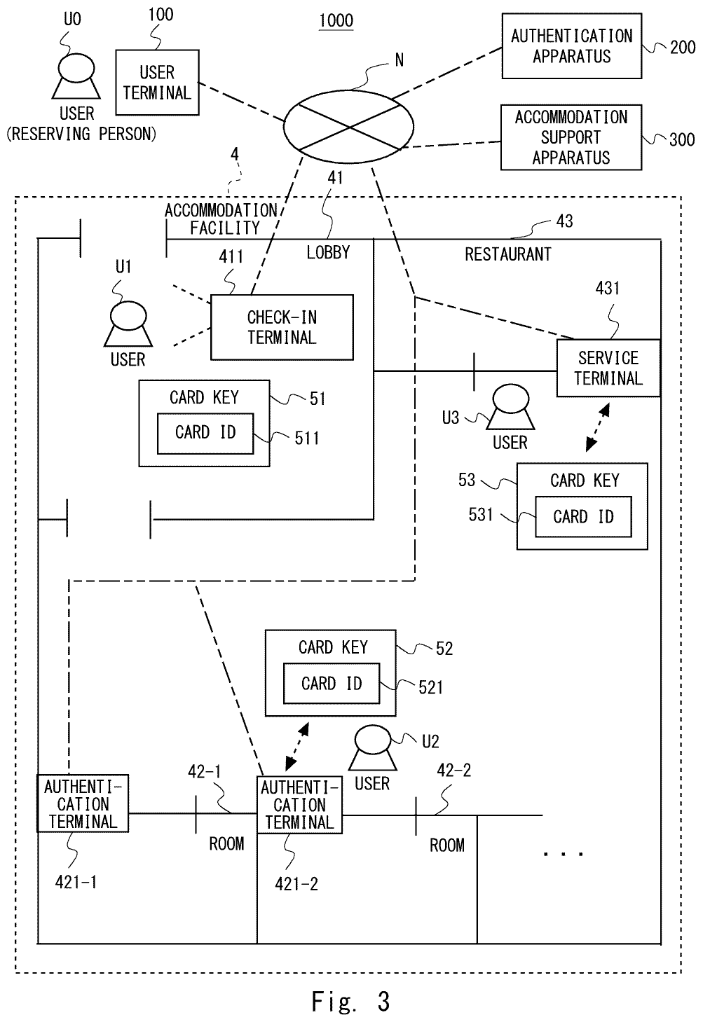

A second example embodiment is a specific example of the first example embodiment described above. FIG. 3 is a block diagram illustrating a configuration of an accommodation support system 1000 according to the second example embodiment. The accommodation support system 1000 is an information system for performing a reservation for an accommodation in accommodation facility 4, check-in, issuance of a card key, provision of a service using the card key, and the like. The accommodation support system 1000 includes a user terminal 100, an authentication apparatus 200, an accommodation support apparatus 300, a check-in terminal 411, authentication terminals 421-1, 421-2, and so on, and a service terminal 431. The user terminal 100, the authentication apparatus 200, the accommodation support apparatus 300, the check-in terminal 411, the authentication terminals 421-1 and the like, and the service terminal 431 are connected to be capable of communicating with each other via a network N. Here, the network N is a communication network including a wireless communication line and is, for example, the Internet, a wireless communication line network, a mobile phone line network, or the like. In addition, the network N may be of any type of communication protocol.

A user U0 is a user who carries and operates the user terminal 100 and makes a reservation for a predetermined accommodation plan in the accommodation facility 4. The user terminal 100 is an information processing terminal by which the user U0 registers reservation information including a face image in advance in the accommodation support apparatus 300. Note that the user U0 may perform registration and the like of the reservation information using an information processing apparatus other than the user terminal 100.

The accommodation facility 4 includes a lobby 41, rooms 42-1, 42-2, and so on, and a restaurant 43 (dining room). The check-in terminal 411 is installed in the lobby 41. The check-in terminal 411 performs check-in for the user U1 who is a visitor of the accommodation facility 4 by face authentication, and lends a card key 51 used to unlock a room where the checked-in user U1 stays to the user U1. At least a card ID 511 is recorded in the card key 51. At this time, the check-in terminal 411 requests the accommodation support apparatus 300 to perform card key issuing processing. According to the card key issuing processing, the card ID 511 is registered in association with a room number of the room (for example, room 42-1) in which the user U1 stays and service information provided to the user U1.

The authentication terminal 421-1 that controls unlocking of a door is installed at an entrance of the room 42-1. In addition, the authentication terminal 421-2 that controls unlocking of a door is installed at an entrance of the room 42-2. Furthermore, an authentication terminal that controls unlocking of a door is similarly installed at an entrance of each room. For example, when the card key 52 is tapped by a user U2, the authentication terminal 421-2 reads a card ID 521, and transmits an authentication request including the card ID 521 and a room number to the accommodation support apparatus 300 via the network N. The accommodation support apparatus 300 collates the card ID 521 included in the authentication request with a card ID associated with the room number, and returns unlocking permission to the authentication terminal 421-2 if the both match. As a result, the authentication terminal 421-2 unlocks the door, and the user U2 can enter the room 42-2. Note that the authentication terminal 421-1 and the like installed at the entrances of the respective rooms have equivalent functions. Note that the authentication terminal 421-1 and the like may be simply referred to as “authentication terminals 421” in the following description.

The service terminal 431 that confirms entry is installed at an entrance of the restaurant 43. When a card key 53 is tapped by a user U3, the service terminal 431 reads a card ID 531, and transmits a service request including the card ID 531 and a service ID of the restaurant 43 to the accommodation support apparatus 300 via the network N. The accommodation support apparatus 300 collates the card ID 531 included in the service request with a card ID associated with the service ID, and performs processing according to information associated with the service ID if the both match. For example, the accommodation support apparatus 300 returns entry permission to the service terminal 431. As a result, the service terminal 431 allows the user U3 to enter the restaurant 43, and the user U3 can enter the restaurant 43 and have a meal.

Note that each of the users U1 to U3 in the accommodation facility 4 may carry an information processing terminal having a function equivalent to that of the user terminal 100. The user terminal 100 present in the accommodation facility 4 may be regarded as a predetermined authentication terminal by the accommodation support apparatus 300. Note that the user U0, U1, U2, or U3 may be simply referred to as a “user U” in the following description. In addition, the user terminals carried by the users U1 to U3 in the accommodation facility 4 may be simply referred to as “user terminals 100” in the following description.

The authentication apparatus 200 is an information processing apparatus that manages face feature information of the user and performs face authentication. In addition, in response to a face authentication request received from the outside, the authentication apparatus 200 collates a face image or face feature information included in the request with the face feature information of each user, and returns a collation result (authentication result) to a request source.

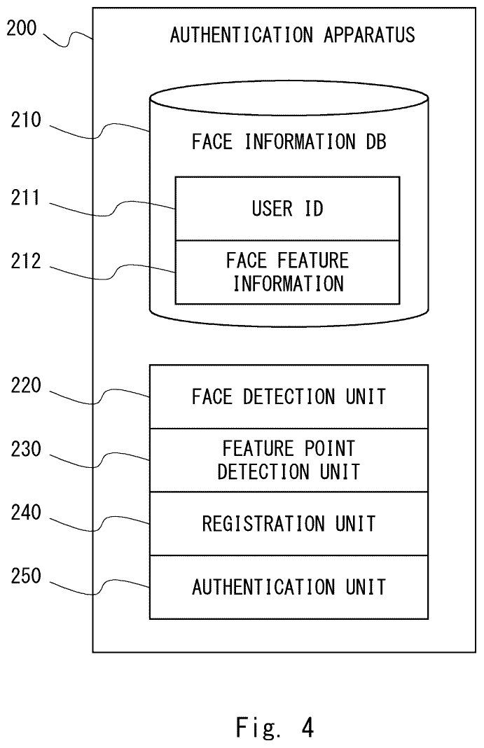

FIG. 4 is a block diagram illustrating a configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a feature vector indicating a set of feature amounts which are a distance and the like between feature points corresponding to positions of eyes, a nose, a mouth, and the like of a person. Note that the authentication apparatus 200 may delete the face feature information 212 in the face information DB 210 in response to a request from a user or the like corresponding to the face feature information 212. Alternatively, the authentication apparatus 200 may delete the face feature information 212 after a lapse of a certain period from the registration of the face feature information.

The face detection unit 220 detects a face area included in a registration image for registering face information, and outputs the face area to the feature point extraction unit 230. The feature point extraction unit 230 extracts feature points from the face area detected by the face detection unit 220, calculates a distance and the like between the extracted feature points as feature amounts, and generates a feature vector including a set of the calculated feature points as face feature information. The feature point extraction unit 230 outputs the generated face feature information to the registration unit 240 or the authentication unit 250.

The registration unit 240 newly issues the user ID 211 when registering the face feature information. The registration unit 240 registers the issued user ID 211 and the face feature information 212 extracted from the registration image in the face information DB 210 in association with each other.

The authentication unit 250 performs face authentication using the face feature information 212. Specifically, the authentication unit 250 calculates a degree of matching with each piece of master biometric information by one-to-N collation between the face feature information (query biometric information) extracted from the face image and the face feature information 212 (master biometric information) in the face information DB 210. For example, the authentication unit 250 may calculate a degree of similarity between a feature amount of the query biometric information and a feature amount of the master biometric information as the degree of matching. For example, the authentication unit 250 preferably calculates the degree of matching to be higher as a distance between feature vectors is shorter. Then, the authentication unit 250 determines that the authentication is successful if the degree of matching is equal to or greater than a threshold value, and determines that the authentication has failed if the degree of matching is less than the threshold value. If the authentication is successful, the authentication unit 250 specifies the user ID 211 associated with the successfully authenticated face feature information 212 from the face information DB 210, and returns a face authentication result including the success in the authentication and the user ID 211 to the request source of the face authentication request. On the other hand, if the authentication has failed, the authentication unit 250 returns a face authentication result including the failure in the authentication to the request source.

Returning to FIG. 3, the description will be continued. The accommodation support apparatus 300 is an example of the accommodation support apparatus 1 described above. The accommodation support apparatus 300 is an information processing apparatus that performs a reservation for an accommodation in accommodation facility 4, check-in, issuance of a card key, provision of a service using the card key, and the like. The accommodation support apparatus 300 may be configured redundantly in a plurality of servers, and each functional block may be implemented by a plurality of computers.

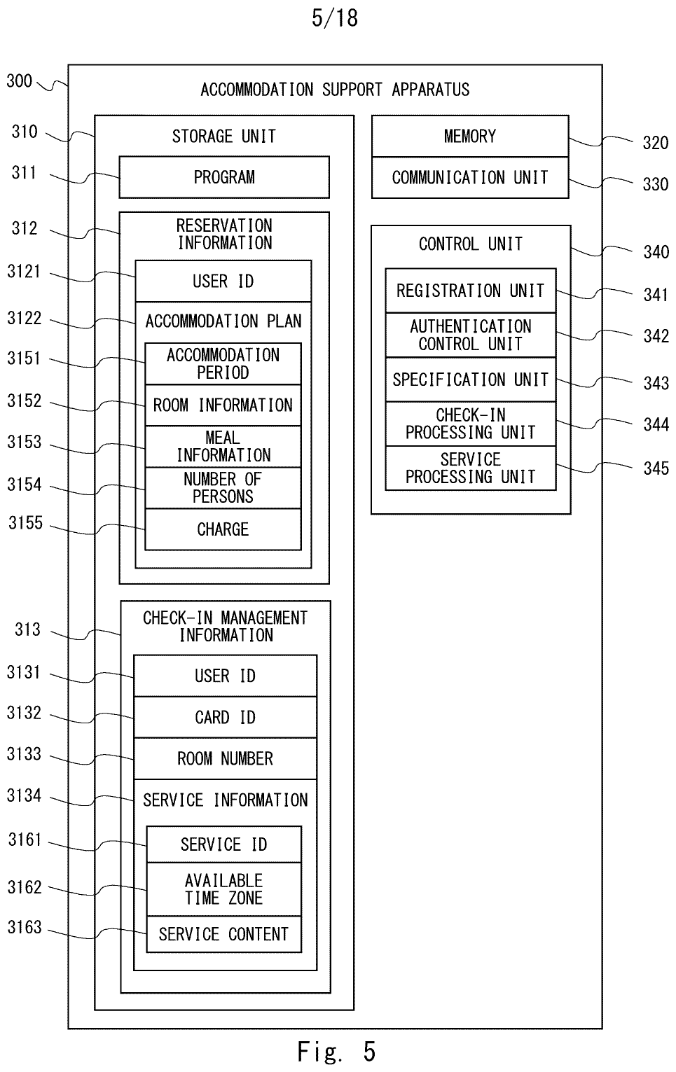

FIG. 5 is a block diagram illustrating a configuration of the accommodation support apparatus 300 according to the second example embodiment. The accommodation support apparatus 300 includes a storage unit 310, a memory 320, a communication unit 330, and a control unit 340. The storage unit 310 is an example of a nonvolatile storage device such as a hard disk or a flash memory. The storage unit 310 stores a program 311, reservation information 312, and check-in management information 313. Note that the storage unit 310 and the face information DB 210 of the authentication apparatus 200 may be collectively regarded as a storage unit. In addition, some or all of pieces of information stored in the storage unit 310 may be stored in an external storage device. The program 311 is a computer program (accommodation support program) in which accommodation support processing and the like including reservation processing, check-in processing, card key issuance processing, service provision processing and the like according to the second example embodiment are implemented.

The reservation information 312 is information for managing details of a reservation for an accommodation plan in the accommodation facility 4. The reservation information 312 is information in which a user ID 3121 and an accommodation plan 3122 are associated with each other. The user ID 3121 is identification information of a reserving person who is the user. The user ID 3121 is information that is the same as or uniquely corresponds to the user ID 211 managed in association with the face feature information 212 in the face information DB 210 of the authentication apparatus 200. Therefore, it is possible to state that the reservation information 312 is information associated with identity authentication information for registration of the user via the user ID 3121.

The accommodation plan 3122 is information indicating reservation content reserved by the user U corresponding to the user ID 3121. The accommodation plan 3122 includes, for example, an accommodation period 3151, room information 3152, meal information 3153, the number of persons 3154, and a charge 3155. The accommodation period 3151 is a period of staying in the accommodation facility 4. In addition, the accommodation period 3151 may be expressed as days of the stay. For example, in the case of one night and two days, the accommodation period 3151 may be the date of the accommodation day. The room information 3152 is information indicating a reserved room type, for example, a floor level, a floor plan, a position in a building (a corner room, facing south, the vicinity of an elevator, and the like), and the like. The meal information 3153 is information indicating whether or not there is a reservation for dinner or breakfast, a menu of a reserved meal, a course, a charge, and the like. The number of persons 3154 is the number of reserved guests, and includes the number of persons for each gender, the number of adults, the number of children, and the like. The number of persons 3154 may include the age of a child. The charge 3155 is a charge for the accommodation plan.

Note that the user ID 3121 may be further associated with attribute information indicating an attribute related to the user U in the reservation information 312. The attribute information may include, for example, family members staying in the same room with the user U. The attribute information may include, for example, information indicating that two beds are enough since there are a couple and one infant who can sleep together. In addition, the attribute information may include personal information of the user U.

The check-in management information 313 is information for managing the guest (reserving person or user) who has checked in on the day and an accommodation plan. The check-in management information 313 is information in which a user ID 3131, a card ID 3132, a room number 3133, and service information 3134 are associated with each other. The user ID 3131 is information corresponding to the aforementioned user ID 3121, and is a user ID for which face authentication is successful at the time of check-in processing. The card ID 3132 is information corresponding to the aforementioned card ID 511 or the like, and is a card ID read at the time of issuing a card. The room number 3133 is identification information of a room assigned to the user at the time of the check-in processing. The service information 3134 is information used to receive provision of various services in the accommodation facility 4. The service information 3134 is information in which a service ID 3161, an available time zone 3162, and service content 3163 are associated with each other. The service ID 3161 is identification information of the service information 3134. The service ID 3161 is, for example, identification information of the restaurant 43. The available time zone 3162 is a time zone in which the corresponding service is available. The available time zone 3162 may be defined by, for example, a use start time and a use end time. The available time zone 3162 is preferably, for example, an available time zone of the restaurant 43 of the accommodation facility 4. Note that, instead of the available time zone 3162, an entry permission flag with respect to the restaurant 43 or the like may be used. The service content 3163 is content that can be used (provided) by the corresponding service. Examples of the service content 3163 include, but are not limited to, meal content (a course menu or an optional menu) provided at the restaurant 43, distinction between dinner and breakfast, entry to a common space such as a table in the restaurant 43 or a public bath, use of a massage machine, and purchase at a vending machine.

The memory 320 is a volatile storage device such as a random access memory (RAM), and is a storage area for temporarily holding information during the operation of the control unit 340. The communication unit 330 is a communication interface with the network N.

The control unit 340 is a processor that controls each component of the accommodation support apparatus 300, that is, a control apparatus. The control unit 340 reads the program 311 from the storage unit 310 into the memory 320 and executes the program 311. As a result, the control unit 340 implements the functions of the registration unit 341, the authentication control unit 342, the specification unit 343, the check-in processing unit 344, and the service processing unit 345.

The registration unit 341 is an example of the registration unit 13 described above. The registration unit 341 performs reservation information registration processing (reservation processing) and the like. Specifically, the registration unit 341 receives a registration request including a face image and an accommodation plan (and attribute information) to be reserved from the user terminal 100 or the like, and registers the reservation information 312. At this time, the registration unit 341 registers the face feature information based on the face image included in the registration request in the authentication apparatus 200, and acquires a user ID issued at the time of registration. Then, the registration unit 341 generates the reservation information 312 by associating the user ID 3121 thus issued with the accommodation plan 3122 (and the attribute information) included in the registration request, and registers the reservation information 312 in the storage unit 310.

In addition, the registration unit 341 acquires the card ID from the check-in terminal 411 at the time of issuing the card key, and generates the service information from the service ID included in the reservation information of the user completing the check-in processing. Then, the registration unit 341 generates the check-in management information 313 in association with the card ID, the user ID, the room number of the user completing the check-in processing, and the service information, and registers the check-in management information 313 in the storage unit 310. At this time, in a case where the reservation information specified by the specification unit 343 includes a food and drink service, the registration unit 341 may register entry permission with respect to the restaurant 43 of the accommodation facility 4 as the service information. In addition, in a case where the registration unit 341 receives selection of a desired use time zone of the restaurant 43 from the user at the time of check-in, the desired use time zone is preferably included in the service information as the available time zone. In addition, the registration unit 341 preferably includes, in the service information, content of a meal provided at the restaurant 43 from the meal information 3153 included in the reservation information.

The authentication control unit 342 controls identity authentication of the user using the authentication apparatus 200. In particular, the authentication control unit 342 according to the present example embodiment controls biometric authentication of the user using biometric information extracted from an image obtained by capturing an image of the user. Specifically, the authentication control unit 342 controls the face authentication of the user using the face feature information extracted from the face image of the user. That is, the authentication control unit 342 causes the authentication apparatus 200 to collate the identity authentication information (query biometric information) for authentication of the user with the face feature information 212 (master biometric information) in the face information DB 210 to control the identity authentication. For example, if a check-in request including a face image is received from the check-in terminal 411, the authentication control unit 342 controls the face authentication.

The specification unit 343 is an example of the specification unit 11 described above. If the face authentication according to the check-in request is successful, the specification unit 343 specifies the user ID included in the face authentication result and specifies the reservation information 312 including the specified user ID 3121.

The check-in processing unit 344 is an example of the check-in unit 12 described above. The check-in processing unit 344 registers check-in management information 313 in the storage unit 310 based on the accommodation plan 3122 associated with the user ID 3121 for which the face authentication is successful. Specifically, the check-in processing unit 344 assigns a room number where the user who has succeeded in the face authentication stays, generates the check-in management information 313 in which the user ID 3131 and the room number 3133 are associated, and registers the generated check-in management information in the storage unit 310. Then, the check-in processing unit 344 transmits a card lending instruction to the check-in terminal 411.

The service processing unit 345 is an example of the service processing unit 14 described above. If the service request including the card ID 531 and the service ID read from the card key 53 is acquired in the service terminal 431, the service processing unit 345 performs processing according to the service information 3134 associated with the card ID 531. Then, the service processing unit 345 returns a result of the processing to the service terminal 431. Specifically, the service processing unit 345 preferably specifies the service information 3134 associated with the card ID 531 (3132) in the check-in management information 313 and return the processing result including the specified service information 3134 to the service terminal 431. As a result, the service terminal 431 can determine the availability of entry based on the service information 3134.

Alternatively, the service processing unit 345 may determine the availability of entry to the restaurant 43 based on the available time zone included in the service information associated with the card ID, and return a determination result to the service terminal 431. As a result, the service terminal 431 can control the entry based on the received determination result as to the availability of entry. In particular, if the service information associated with the card ID includes the entry permission (flag), the service processing unit 345 preferably determines to permit the entry to the restaurant 43.

Alternatively, the service processing unit 345 preferably specifies the meal content included in the service information associated with the card ID, and performs processing according to the specified meal content. For example, the service processing unit 345 may perform guidance to a table in the restaurant 43, order processing according to a menu or a course, a meal provision instruction, and the like as the service provision processing.

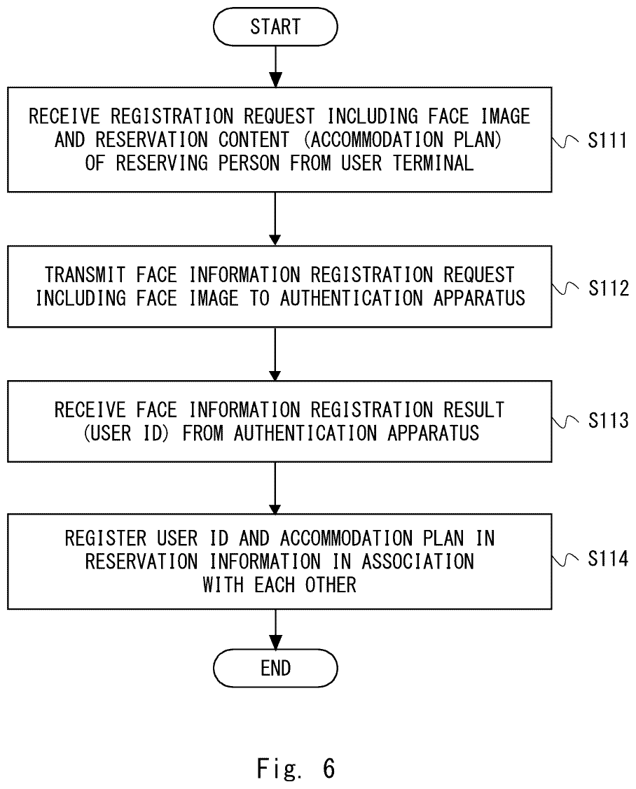

FIG. 6 is a flowchart illustrating a flow of the reservation processing according to the second example embodiment. For example, the user terminal 100 receives input or selection of reservation content (an accommodation plan) (and attribute information of the user U0) in the accommodation facility 4 according to an operation of the user U0. Then, the user terminal 100 controls a built-in camera (not illustrated) according to a registration operation from the user U0 to capture an image of a face of the user U0, and acquires the captured face image. Then, the user terminal 100 transmits a registration request of the face image and the reservation content (and attribute information) to the accommodation support apparatus 300.

In response to this, the accommodation support apparatus 300 receives the registration request including the face image of the user U1 and the reservation content (accommodation plan) (and attribute information) from the user terminal 100 via the network N (S111). Then, the accommodation support apparatus 300 transmits a face information registration request including the face image to the authentication apparatus 200 via the network N (S112). In response to the transmission, the authentication apparatus 200 performs face information registration processing.

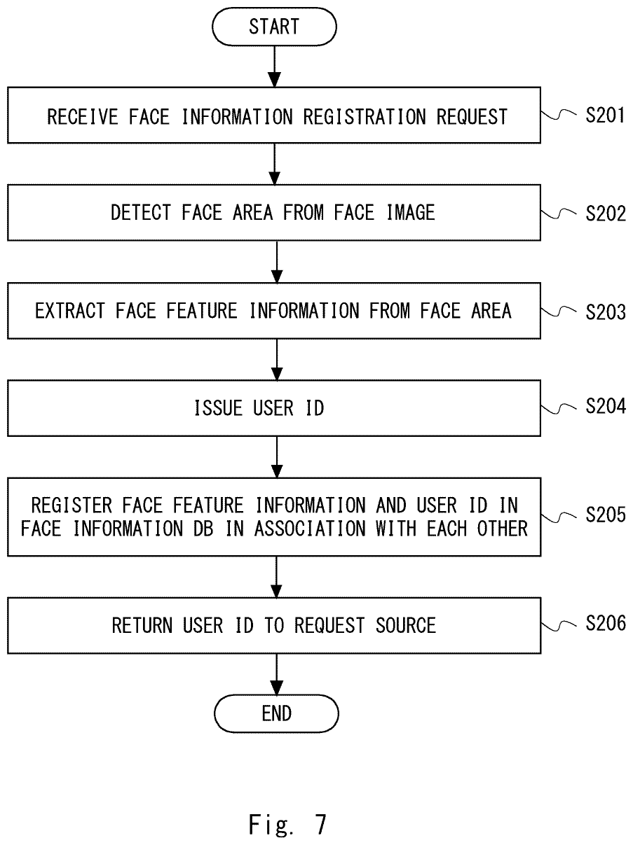

FIG. 7 is a flowchart illustrating a flow of the face information registration processing performed by the authentication apparatus 200 according to the second example embodiment. First, the authentication apparatus 200 receives a face information registration request from the accommodation support apparatus 300 via the network N (S201). Then, the face detection unit 220 of the authentication apparatus 200 detects a face area from a face image included in the face information registration request (S202). Then, the feature point extraction unit 230 of the authentication apparatus 200 extracts face feature information from the face area detected in step S202 (S203). Then, the registration unit 240 of the authentication apparatus 200 issues the user ID 211 (S204). Then, the registration unit 240 registers the extracted face feature information 212 and the issued user ID 211 in association with each other in the face information DB 210 (S205). Thereafter, the registration unit 240 returns the issued user ID 211 to the accommodation support apparatus 300, which is a request source, via the network N (S206). Note that the authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 6, the description will be continued. The accommodation support apparatus 300 receives a face information registration result from the authentication apparatus 200 (S113). The face information registration result includes the user ID issued by the authentication apparatus 200. Then, the accommodation support apparatus 300 registers the user ID 3121 included in the face information registration result with the accommodation plan 3122 (and the attribute information) included in the registration request in the storage unit 310 in association with each other as the reservation information 312 (S114).

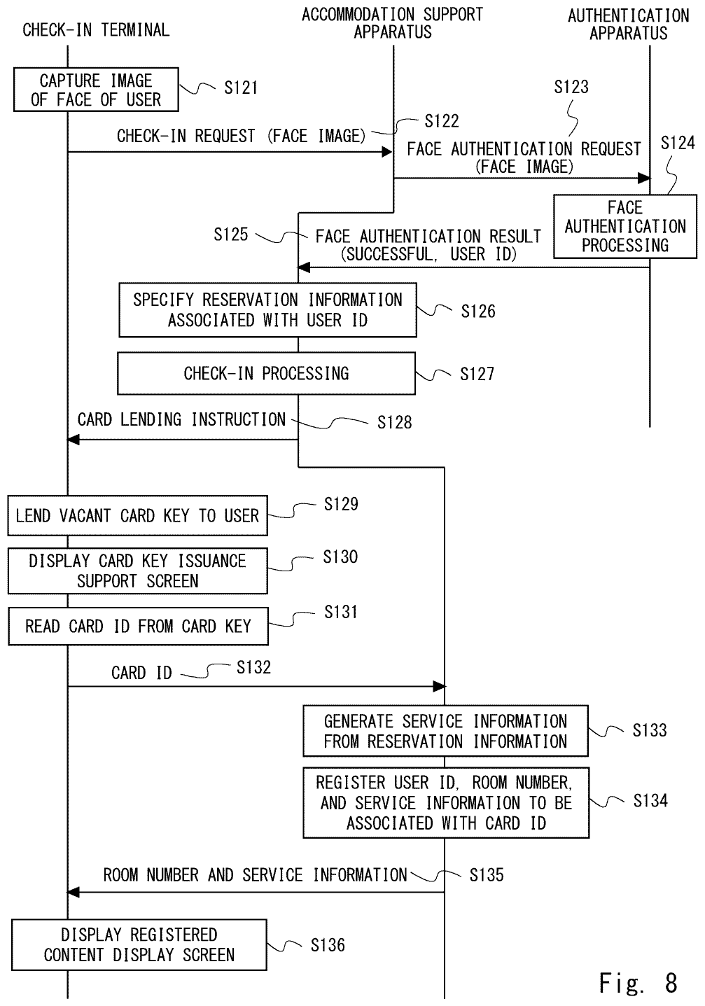

FIG. 8 is a sequence diagram illustrating a flow of the check-in processing according to the second example embodiment. First, the check-in terminal 411 detects a person (for example, the user U1) entering the accommodation facility 4 by a human detection sensor (not illustrated) or the like, and displays a check-in screen prompting face authentication. The user U1 stands in front of a camera (not illustrated) of the check-in terminal 411 according to the check-in screen. Then, the check-in terminal 411 captures an image of a face of the user U1 (S121). Then, the check-in terminal 411 transmits a check-in request including the captured face image of the user U1 to the accommodation support apparatus 300 via the network N (S122).

In response to this, the accommodation support apparatus 300 receives the check-in request from the check-in terminal 411 via the network N. Then, the accommodation support apparatus 300 transmits a face authentication request including the face image included in the received check-in request to the authentication apparatus 200 via the network N (S123). In response to this, the authentication apparatus 200 performs face authentication processing (S124).

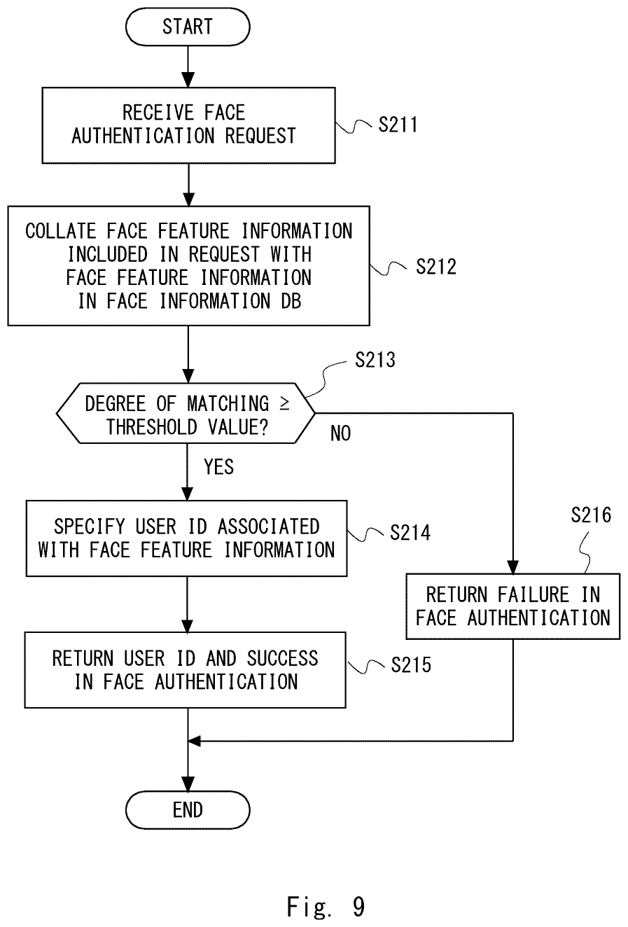

FIG. 9 is a flowchart illustrating a flow of the face authentication processing performed by the authentication apparatus 200 according to the second example embodiment. First, the authentication apparatus 200 receives a face authentication request from the accommodation support apparatus 300 via the network N (S211). Then, the authentication apparatus 200 extracts face feature information from a face image included in the face authentication request similarly to steps S202 and S203 described above. Then, the authentication unit 250 of the authentication apparatus 200 collates the face feature information extracted from the face image included in the face authentication request with the face feature information 212 of the face information DB 210 (S212), and calculates a degree of matching. Then, the authentication unit 250 determines whether or not the degree of matching is equal to or greater than a threshold value (S213). If the pieces of face feature information match, that is, if the degree of matching between the pieces of face feature information is equal to or greater than the threshold value, the authentication unit 250 specifies the user ID 211 associated with the face feature information 212 (S214). Then, the authentication unit 250 transmits, as a response, a face authentication result including the success in the face authentication and the specified user ID 211 to the accommodation support apparatus 300 via the network N (S215). If the degree of matching is less than the threshold value in step S213, the authentication unit 250 returns a face authentication result including information indicating the failure in the face authentication to the accommodation support apparatus 300 via the network N (S216).

Returning to FIG. 8, the description will be continued. The accommodation support apparatus 300 receives the face authentication result from the authentication apparatus 200 via the network N. Then, the accommodation support apparatus 300 determines whether or not the face authentication is successful. Specifically, the accommodation support apparatus 300 refers to the face authentication result and determines that the face authentication is successful if the face authentication result includes the user ID. Note that, if it is determined that the face authentication has failed, the accommodation support apparatus 300 may return the fact that the face authentication has failed or that the check-in is impossible to the check-in terminal 411 via the network N.

If the face authentication is successful, the accommodation support apparatus 300 specifies the accommodation plan 3122 (that is, the reservation information 312) associated with the user ID 3121 included in the face authentication result (S126). Then, the accommodation support apparatus 300 performs the check-in processing for the reservation information 312 (S127). Specifically, the accommodation support apparatus 300 assigns a vacant room corresponding to a type or the like of the room information 3152 included in the reservation information 312 to the user U1. Then, the accommodation support apparatus 300 associates the room number 3133 of the assigned room with the user ID 3131 included in the face authentication result received in step 125 to generate the check-in management information 313, and registers the generated check-in management information in the storage unit 310. Then, the accommodation support apparatus 300 transmits a card lending instruction to the check-in terminal 411 via the network N (S128).

In response to the card lending instruction received from the accommodation support apparatus 300 via the network N, the check-in terminal 411 lends the card key 51, which is vacant (has not been lent), to the user U1 (S129). For example, the check-in terminal 411 may output the card key 51 from a card output unit (not illustrated) and cause the user U1 to take the card key. Then, a card key issuance support screen of the check-in terminal 411 is displayed (S130).

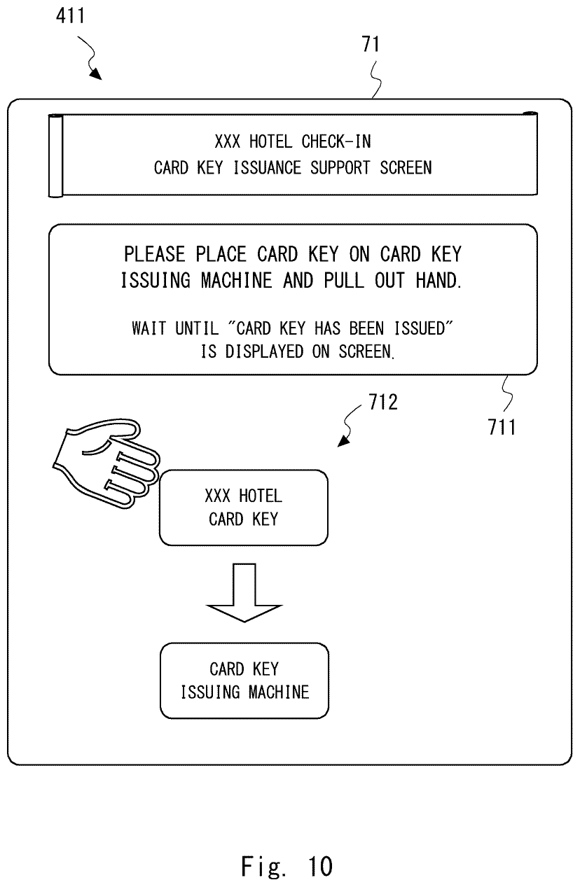

FIG. 10 is a view illustrating a display example of a card key issuance support screen 71 according to the second example embodiment. The card key issuance support screen 71 illustrates an example of being displayed on the check-in terminal 411. The card key issuance support screen 71 includes a support message 711 and a support image 712. Note that display content of the card key issuance support screen 71 is not limited thereto. The support message 711 is a message (text information) for supporting an operation to issue the card key to the user U1 to whom the card key 51 is lent. The support message 711 indicates an example such as “Please place card key on card key issuing machine and pull out hand.” or “Please wait until “Card key has been issued.” is displayed on screen.”, but is not limited thereto. The support image 712 conveys, as an image, an operation of placing the card key 51 on the card key issuing machine to the user U1.

Here, it is assumed that the user U1 has placed the lent card key 51 on the card issuing machine (not illustrated) connected to the check-in terminal 411 and pulled out his/her hand. In response to this, the check-in terminal 411 acquires the card ID 511 read from the card key 51 by the card issuing machine (S131), and transmits the card ID 511 to the accommodation support apparatus 300 via the network N (S132).

In response to this, the accommodation support apparatus 300 acquires the card ID 511 from the check-in terminal 411 via the network N, and specifies the check-in management information 313 associated with the card ID 511 (3122). Then, the accommodation support apparatus 300 specifies the accommodation plan 3122 associated with the user ID 3131 (3121) included in the specified check-in management information 313 from the reservation information 312. Note that the accommodation support apparatus 300 may specify the accommodation plan 3122 from the user ID 3121 included in the face authentication result received in step 125. That is, the accommodation support apparatus 300 generates the service information of the user by using the meal information 3153 or the like of the accommodation plan 3122 of the reservation information 312 of the user who has succeeded in the face authentication (S133). Specifically, the accommodation support apparatus 300 specifies a service ID indicating provision of a meal by a food and drink service or the restaurant 43 from the meal information 3153, and generates the service information 3134 by associating the service ID 3161, the available time zone 3162 of the restaurant 43 for the user U1, and the service content 3163. Then, the accommodation support apparatus 300 registers the user ID 3131 of the user U1, the acquired card ID 511 (3122), the room number 3133, and the generated service information 3134 in the storage unit 310 as the check-in management information 313 in association with each other (S134).

Thereafter, the accommodation support apparatus 300 transmits the room number 3133, the service information 3134, and the like to the check-in terminal 411 via the network N (S135). In response to this, the check-in terminal 411 displays a registered content display screen including the received room number 3133, the received service information 3134, and the like (S136).

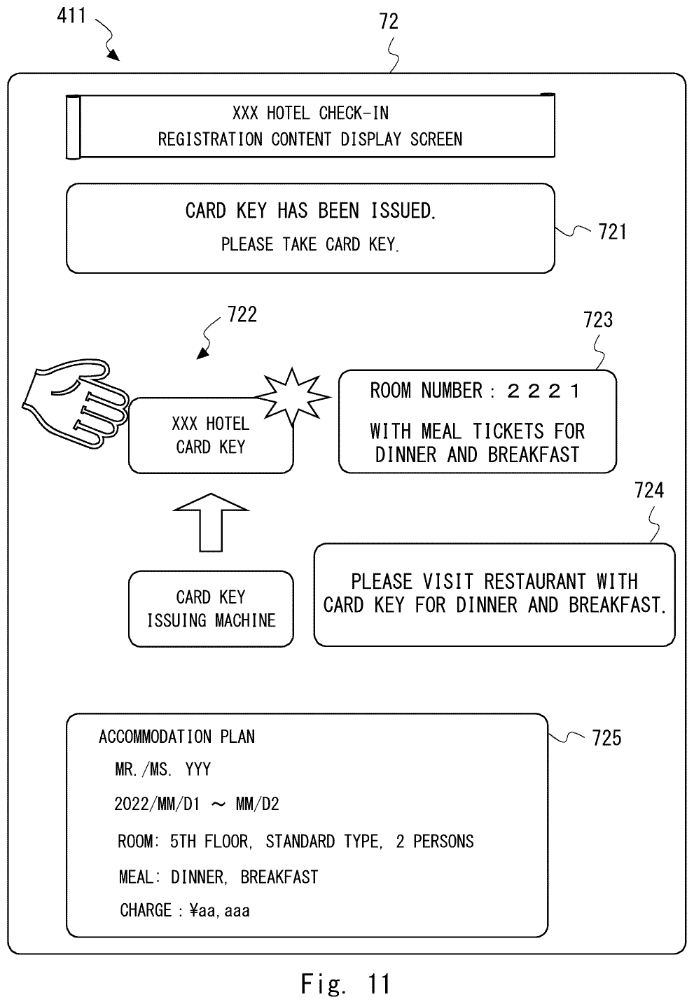

FIG. 11 is a view illustrating a display example of a registered content display screen 72 according to the second example embodiment. The registered content display screen 72 illustrates an example of being displayed on the check-in terminal 411. The registered content display screen 72 includes a support message 721, a support image 722, room number and meal ticket information 723, a support message 724, and registered content 725. Note that display content of the registered content display screen 72 is not limited thereto. The support message 721 is a message (text information) for supporting the user U1 in receiving the issued card key 51. The support message 721 indicates an example such as “Card key has been issued.” or “Please take card key.”, but is not limited thereto. The support image 722 conveys, as an image, an operation of picking up and taking the card key 51 from the card key issuing machine to the user U1. The room number and meal ticket information 723 indicates that the card ID 511 of the card key 51 is associated with a room number “2221” and meal tickets for dinner and breakfast. Note that the room number and meal ticket information 723 may be information displayed including assigned time (available time, distinction between the first half and the second half, or the like) and a place for dinner and breakfast. The support message 724 is a message (text information) for conveying that the card key 51 serves as a meal ticket and can be used at the restaurant 43. The support message 724 indicates an example such as “Please visit restaurant with card key for dinner and breakfast.”, but is not limited thereto. The registered content 725 indicates an example of information indicating registered content of the accommodation plan of the user U1, but is not limited thereto.

As described above, the check-in processing and the card key issuance processing according to the present example embodiment are performed. Next, the service provision processing according to the present example embodiment will be described with reference to Examples 2-1 to 2-3.

(Example 2-1) The accommodation support apparatus 300 specifies service information corresponding to a card ID read from a card key, and performs processing of returning the specified service information to an authentication terminal (for example, a service terminal) of a request source.

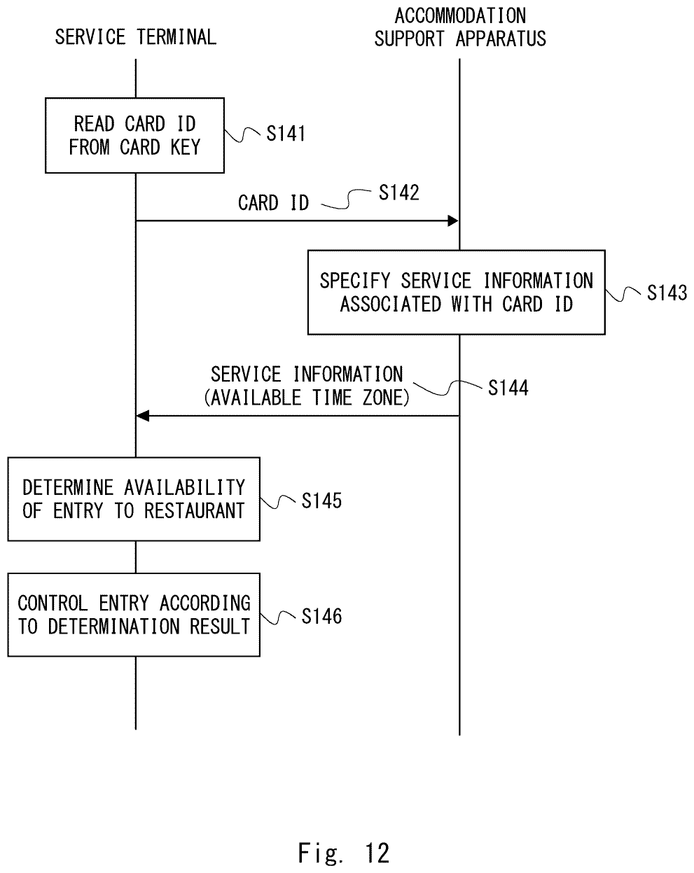

FIG. 12 is a sequence diagram illustrating a flow of service provision processing according to Example 2-1 of the second example embodiment. First, the service terminal 431 reads the card ID 531 from the card key 53 of the user U3 (S141). Then, the service terminal 431 transmits the read card ID 531 to the accommodation support apparatus 300 via the network N (S142). In response to this, the accommodation support apparatus 300 acquires the card ID 531 from the check-in terminal 411 via the network N, and specifies the service information 3134 associated with the card ID 531 (3122) from the check-in management information 313 (S143). At this time, it is assumed that the service information 3134 includes the available time zone 3162. Then, the accommodation support apparatus 300 transmits the service information 3134 including the available time zone 3162 to the service terminal 431 via the network N (S144). The service terminal 431 receives the service information 3134 from the accommodation support apparatus 300 via the network N. Then, the service terminal 431 determines whether or not the user U3 can enter the restaurant 43 based on the available time zone 3162 of the service information 3134 (S145). The service terminal 431 performs entry control according to a determination result of step S145 (S146). For example, if the current time is included in the available time zone in step S145, the service terminal 431 determines to permit the entry, displays a meal ticket confirmation screen, and opens an entrance gate (not illustrated) or the like of the restaurant 43. As a result, the user U3 recognizes that he/she can enter the restaurant 43 in this time zone, and can enter the restaurant 43 using the card key 53 without using a meal ticket as a paper ticket.

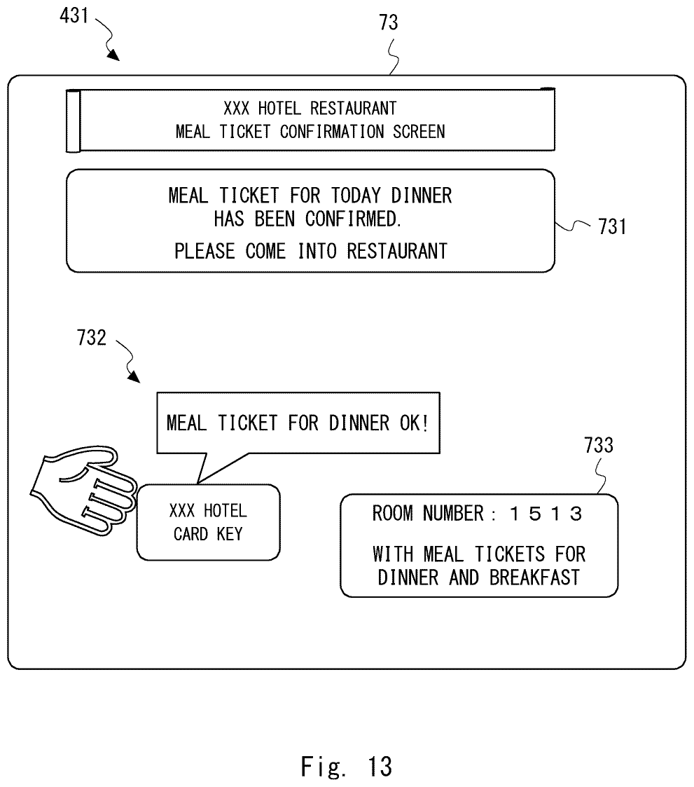

FIG. 13 is a view illustrating a display example of a meal ticket confirmation screen 73 according to Example 2-1 of the second example embodiment. The meal ticket confirmation screen 73 illustrates an example displayed on the service terminal 431. The meal ticket confirmation screen 73 includes a support message 731, a support image 732, and room number and meal ticket information 733. Note that display content of the meal ticket confirmation screen 73 is not limited thereto. The support message 731 is a message (text information) for conveying that a meal ticket has been confirmed by tapping the card key 53. The support message 731 indicates an example such as “Meal ticket for today dinner has been confirmed.” or “Please come into restaurant.”, but is not limited thereto. The support image 732 conveys, as an image, that the meal ticket for dinner is associated with the card ID 531 of the card key 53 tapped by the user U3. The room number and meal ticket information 733 indicates that the card ID 531 of the card key 53 is associated with a room number “1513” and meal tickets for dinner and breakfast. Note that the meal ticket confirmation screen 73 may display a table position, a table number, a menu, and a course menu name indicated by a meal ticket.

On the other hand, if the current time is not included in the available time zone in step S145, the service terminal 431 determines not to permit the entry and conveys the determination to the user U3 by a display on the screen or the like. As a result, the user U3 can recognize that he/she cannot enter the restaurant 43 in this time zone.

(Example 2-2) The accommodation support apparatus 300 specifies service information corresponding to a card ID read from a card key, determines availability of a service based on the specified service information, and returns a determination result to an authentication terminal (for example, a service terminal) of a request source. A difference from Example 2-1 is that the accommodation support apparatus (server or the like) determines whether or not the service can be used instead of the authentication terminal such as the service terminal.

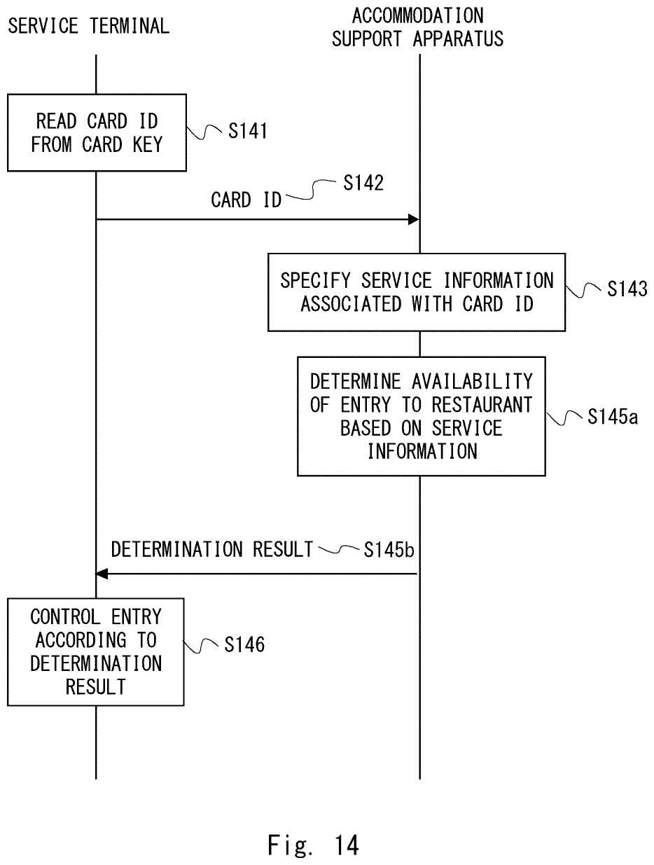

FIG. 14 is a sequence diagram illustrating a flow of service provision processing according to Example 2-2 of the second example embodiment. Steps S141 to S143 are similar to those in FIG. 12 described above. Then, the accommodation support apparatus 300 determines whether or not the user U3 can enter the restaurant 43 based on the available time zone 3162 of the service information 3134 specified in step S143 (S145a). Then, the accommodation support apparatus 300 transmits a determination result of step S145a to the service terminal 431 via the network N (S145b). Thereafter, the service terminal 431 performs entry control according to the determination result received in step S145b (S146).

(Example 2-3) The accommodation support apparatus 300 performs service provision processing according to the determination result of Example 2-2.

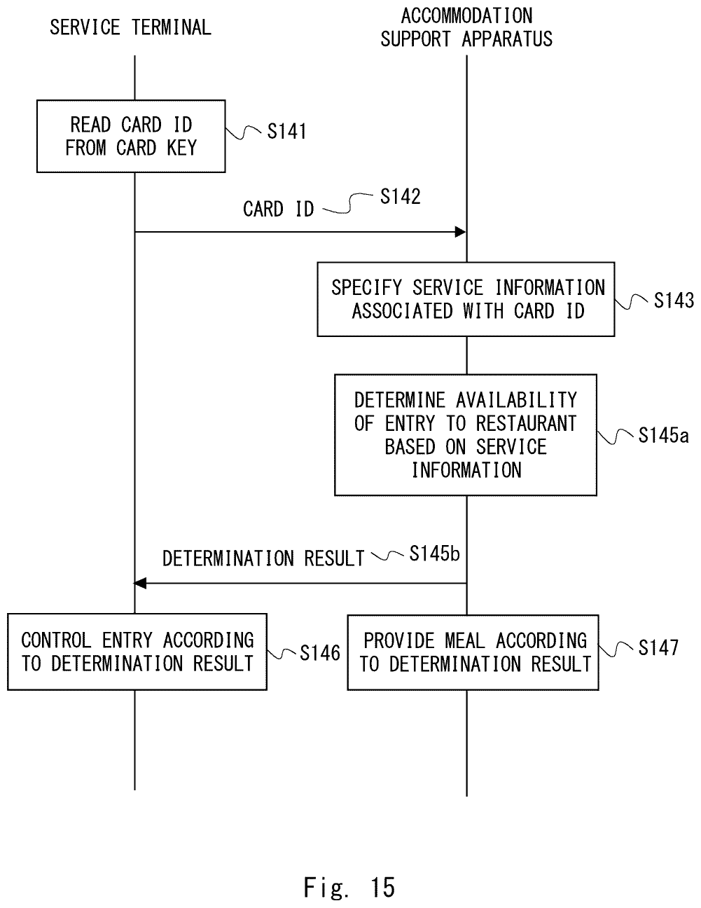

FIG. 15 is a sequence diagram illustrating a flow of service provision processing according to Example 2-3 of the second example embodiment. Steps S141 to S146 are similar to those in FIG. 14 described above. Then, the accommodation support apparatus 300 provides a meal according to the determination result of step S145a (S147). For example, if the determination result of step S145a indicates permission of the entry, the accommodation support apparatus 300 transmits a request of ordering a menu indicated by the service content 3163 of the service information 3134 and a notification of a table position of the user U3 to a terminal of the kitchen of the restaurant 43. In addition, the accommodation support apparatus 300 may transmit guidance information to a table included in the service content 3163 to the service terminal 431. Note that, if the determination result of step S145a indicates that non-permission of the entry, the accommodation support apparatus 300 may transmit, to the service terminal 431, information indicating the availability in another available time zone or with an additional charge.

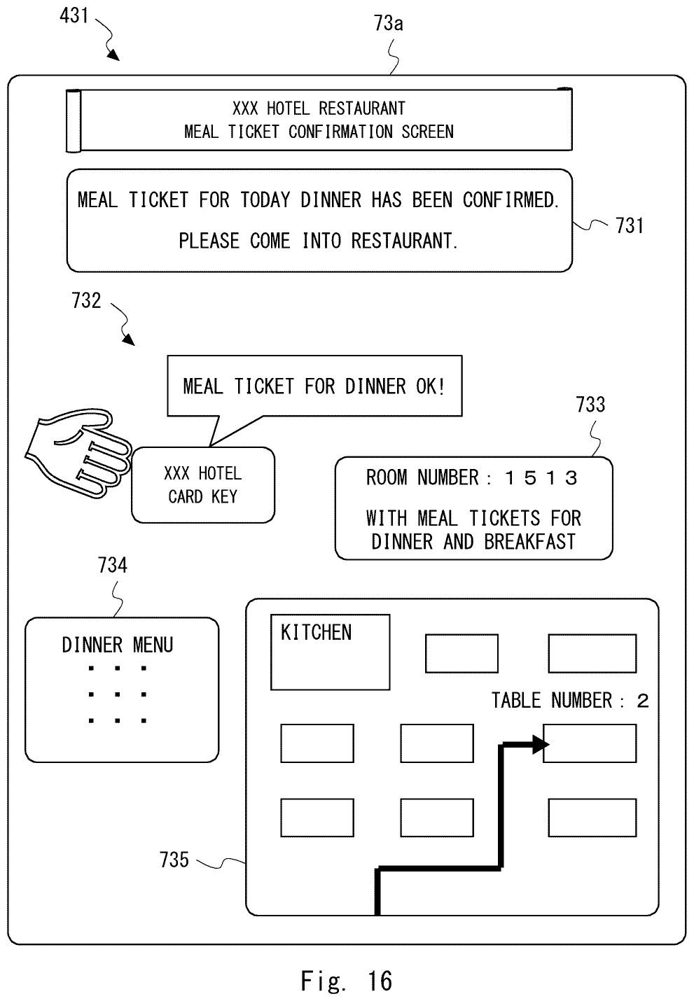

FIG. 16 is a diagram illustrating a display example of a meal ticket confirmation screen 73a according to Examples 2-1 to 2-3 of the second example embodiment. The meal ticket confirmation screen 73a illustrates an example displayed on the service terminal 431. The meal ticket confirmation screen 73a is obtained by adding a menu display field 734 and a table guide diagram 735 in addition to FIG. 13 described above. The menu display field 734 is a field for displaying a menu of reserved dinner, a course menu name, and the like. The table guide diagram 735 illustrates map (route) information for guidance to a table position corresponding to a table number in the restaurant 43 with the table number assigned to the meal ticket being “2”. Note that display content of the meal ticket confirmation screen 73a is not limited thereto.

Note that the accommodation support apparatus 300 may notify a staff terminal (not illustrated) of the information in step S144 or S145b. As a result, a staff of the accommodation facility 4 heads to the vicinity of the entrance of the restaurant 43 as necessary, and easily supports the user U3.

As described above, a meal ticket function is included in a card key lent to a guest without issuing a meal ticket as a paper ticket according to the present example embodiment, so that it is possible to provide various services in an accommodation facility including provision of a meal to the guest in a paperless manner. Therefore, the convenience of the guest is improved, the burden of the staff confirming the paper ticket can be mitigated, and work efficiency can be improved.

### Third Example Embodiment

A third example embodiment is a modified example of the second example embodiment described above. A service processing unit according to the third example embodiment receives a reference request including a card ID read from a card key by a predetermined authentication terminal and identity authentication information acquired from a holder of the card key. Then, if the identity authentication of the holder using the identity authentication information is successful, the service processing unit specifies service information and reservation information associated with the card ID included in the reference request. Thereafter, the service processing unit returns the specified service information and reservation information to the authentication terminal.

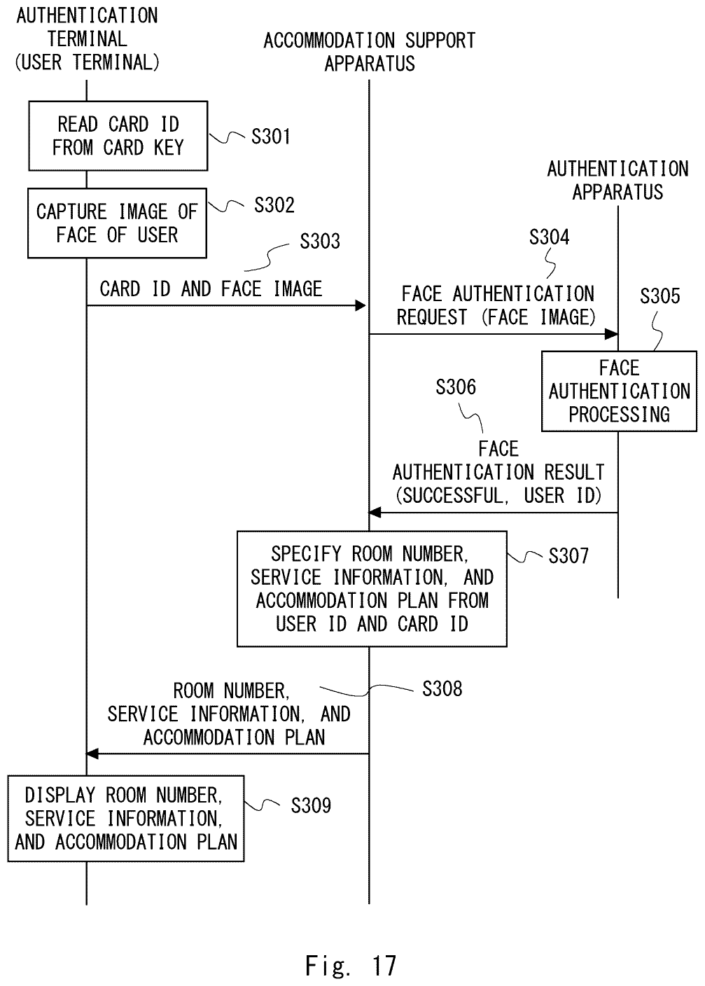

FIG. 17 is a sequence diagram illustrating a flow of processing of referring to registration information of a card key according to the third example embodiment. Here, the “predetermined authentication terminal” will be described as the user terminal 100 carried by the user U2 in the accommodation facility 4. First, the user terminal 100 reads the card ID 521 from the card key 52 of the user U2 (S301). Next, the user terminal 100 controls a camera (not illustrated) to capture an image of a face of the user U2 (S302). Then, the user terminal 100 transmits a reference request including the card ID 521 read in step S301 and the face image of the user U2 captured in step S302 to the accommodation support apparatus 300 via the network N (S303). Note that the user terminal 100 includes current position information in the reference request.

In response to this, the accommodation support apparatus 300 receives the reference request from the user terminal 100 via the network N. At this time, the accommodation support apparatus 300 determines whether or not the position information included in the reference request is within the accommodation facility 4. If the position information is outside the accommodation facility 4, the accommodation support apparatus 300 returns the fact that indicating that the reference is impossible to the user terminal 100. On the other hand, if the position information is within the accommodation facility 4, the accommodation support apparatus 300 transmits a face authentication request including the face image included in the received reference request to the authentication apparatus 200 via the network N (S304). In response to this, the authentication apparatus 200 performs face authentication processing as in FIG. 9 described above (S305). Then, the accommodation support apparatus 300 receives a face authentication result from the authentication apparatus 200 via the network N (S306). Then, the accommodation support apparatus 300 determines whether or not the face authentication is successful. Note that, if it is determined that the face authentication has failed, the accommodation support apparatus 300 may return, to the user terminal 100 via the network N, the fact that the user has failed in the face authentication or that the reference is impossible. In the following description, it is assumed that the face authentication is successful.

If the face authentication is successful, the accommodation support apparatus 300 specifies a room number, service information, and an accommodation plan from a user ID and the card ID (S307). Specifically, the accommodation support apparatus 300 specifies the room number 3133 and the service information 3134 associated with a set of the user ID 3131 included in the face authentication result and the card ID 3132 included in the reference request from the check-in management information 313. In addition, the accommodation support apparatus 300 specifies the accommodation plan 3122 associated with the user ID 3121 included in the face authentication result from the reservation information 312.

Thereafter, the accommodation support apparatus 300 transmits the specified room number, service information, and accommodation plan to the user terminal 100 via the network N (S308). In response to this, the user terminal 100 displays a registered content display screen including the received room number, service information, and accommodation plan and the like (S309).

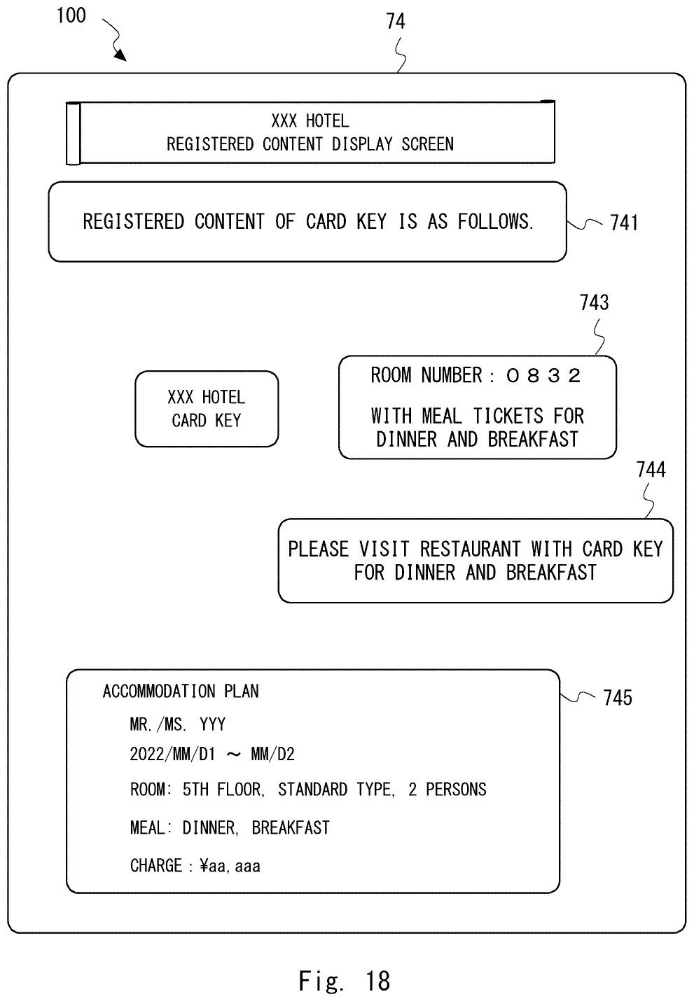

FIG. 18 is a view illustrating a display example of a registered content display screen 74 according to the third example embodiment. The registered content display screen 74 illustrates an example of being displayed on the user terminal 100. The registered content display screen 74 includes a support message 741, room number and meal ticket information 743, a support message 744, and registered content 745. Note that display content of the registered content display screen 74 is not limited thereto. The support message 741 is a message (text information) for guiding the registered content of the card key 52. The room number and meal ticket information 743 indicate that the card ID 521 of the card key 52 is associated with a room number “0832” and meal tickets for dinner and breakfast. Note that the room number and meal ticket information 743 may be information displayed including assigned time (available time, distinction between the first half and the second half, or the like) and a place for dinner and breakfast. The support message 744 and the registered content 745 are similar to the support message 724 and the registered content 725 in FIG. 11 described above.

The “predetermined authentication terminal” described above may be the check-in terminal 411, the authentication terminal 421, the service terminal 431, or the like installed in the accommodation facility 4.

As described above, in the present example embodiment, a guest can easily confirm the room number and the service information available to the guest, content of the accommodation plan, and the like using the card key and the identity authentication at any timing using the user terminal 100 or the authentication terminal of the accommodation facility 4. Therefore, it is possible to provide an optimal use environment for a guest in consideration of various use needs. In addition, it is possible to prevent misuse such as use of the card key by another person.

### Other Example Embodiment

Note that the identity authentication processing for the reserving person (user) at the time of check-in in each of the example embodiments described above is not limited to the face authentication described above. For example, the identity authentication processing for the reserving person at the time of check-in may be performed by collating personal information such as a name and a telephone number input by the reserving person at the time of the check-in terminal with personal information registered if a reservation is made. In addition, the identity authentication processing for the reserving person at the time of check-in may be performed by collating a reservation number input from the reserving person at the time of the check-in terminal with a reservation number issued when a reservation is made. In addition, the personal information and the reservation number of the reserving person may be input by causing the check-in terminal to read code information (for example, a QR code (registered trademark)) displayed on a screen of a user terminal carried by the reserving person or code information printed on a sheet. Therefore, the user ID included in the check-in management information may be any user ID for which the identity authentication processing is successful without being limited to the face authentication. Similarly, in each of the example embodiments described above, other identity authentication information may be registered in the reservation processing, instead of registering the face feature information based on the face image.

Note that the aforementioned example embodiments have been described on the assumption that the identity authentication (authentication for confirming the identity, identity specification processing, and the like) is based on the face authentication, other biometric authentication using biometric information may also be performed. As the biometric authentication and the biometric information, other technologies using a captured image of a person can be applied. For example, as the biometric information, data (feature amount) calculated from physical features unique to an individual such as a fingerprint, a voiceprint, a vein, a retina, an iris of a pupil, and a pattern (pattern) of a palm may be used. In addition, for the biometric authentication, feature information indicating the physical features of a person may be extracted from the captured image of a part of the body of the user, the extracted feature information may be collated with feature information registered in advance, and the authentication may be regarded as being successful if the degree of matching is equal to or greater than the threshold value. For example, the biometric authentication may be authentication based on an appearance shape of the person. In this case, the feature information is information regarding the appearance shape of the person, for example, information indicating features such as a body shape, a height, and clothes. In addition, instead of the biometric authentication, another identity authentication may be applied, and the biometric information may also be another identity authentication information. Examples of the identity authentication information include, but are not limited to, a combination of a user ID, an ID, and a password, description contents (an identification number and the like or a password) of an identification card such as an individual number and a driver's license, an electronic certificate, and code information. Note that the code information may be a two-dimensional code, for example, a QR code (registered trademark).

Note that the authentication apparatus 200 and the accommodation support apparatus 300 have been described as different information processing apparatuses in the aforementioned second example embodiment and the like, but may be the same. For example, the accommodation support apparatus 300 may further register face feature information in association with the user ID 3121 of the reservation information 312. In this case, the control unit 340 only needs to further have the functions of the face detection unit 220, the feature point extraction unit 230, the registration unit 240, and the authentication unit 250 in FIG. 4.

In the above-described example, the program includes a group of instructions (or software codes) for causing a computer to execute one or more functions described in the example embodiments if the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist. In addition, the present disclosure may be implemented by appropriately combining the example embodiments.

Some or all of the above example embodiments may be described as the following Supplementary Notes, but are not limited to the following.

### Supplementary Note A1

An accommodation support apparatus including:
a specification means for specifying reservation information of a user by identity authentication of the user in an accommodation facility;
a check-in means for performing check-in processing for the user based on the reservation information;
a registration means for registering a card ID recorded in a card key, used to unlock a room where the user completing the check-in processing stays and service information regarding a service included in the reservation information in association with each other; and
a service processing means for performing processing according to the service information associated with the card ID if a request including the card ID read from the card key is acquired.

### Supplementary Note A2

The accommodation support apparatus according to Supplementary Note A1, wherein the service processing means receives a request including the card ID read from the card key by a service terminal of the accommodation facility from the service terminal, and returns a result of the processing to the service terminal.

### Supplementary Note A3

The accommodation support apparatus according to Supplementary Note A2, wherein the service processing means specifies the service information associated with the card ID included in the request, and returns the result of the processing including the specified service information to the service terminal.

### Supplementary Note A4

The accommodation support apparatus according to Supplementary Note A3, wherein the service information includes an available time zone of a dining room of the accommodation facility.

### Supplementary Note A5

The accommodation support apparatus according to Supplementary Note A4, wherein the service processing means determines availability of entry to the dining room based on the available time zone included in the service information associated with the card ID, and returns a determination result to the service terminal.

### Supplementary Note A6

The accommodation support apparatus according to any one of Supplementary Notes A1 to A5, wherein
the registration means registers entry permission with respect to the dining room of the accommodation facility as the service information if the reservation information includes a food and drink service, and
the service processing means determines to permit entry to the dining room if the service information associated with the card ID includes the entry permission.

### Supplementary Note A7

The accommodation support apparatus according to any one of Supplementary Notes A1 to A6, wherein the service information includes meal content provided in a dining room of the accommodation facility.

### Supplementary Note A8

The accommodation support apparatus according to Supplementary Note A7, wherein the service processing means specifies meal content included in the service information associated with the card ID, and performs processing according to the specified meal content.

### Supplementary Note A9

The accommodation support apparatus according to any one of Supplementary Notes A1 to A8, wherein the service processing means
receives a reference request including the card ID read from the card key by a predetermined authentication terminal and identity authentication information acquired from a holder of the card key,
specifies the service information and the reservation information associated with the card ID included in the reference request if identity authentication of the holder using the identity authentication information is successful, and
returns the specified service information and reservation information to the authentication terminal.

### Supplementary Note B1

An accommodation support system including:
an authentication terminal installed in an accommodation facility; and
an accommodation support apparatus,
the accommodation support apparatus including:
a specification means for specifying reservation information of a user by identity authentication of the user using the authentication terminal in the accommodation facility;
a check-in means for performing check-in processing for the user based on the reservation information;
a registration means for registering a card ID recorded in a card key, used to unlock a room where the user completing the check-in processing stays and service information regarding a service included in the reservation information in association with each other; and
a service processing means for performing processing according to the service information associated with the card ID if a request including the card ID read from the card key is acquired.

### Supplementary Note B2

The accommodation support system according to Supplementary Note B1, wherein the service processing means receives a request including the card ID read from the card key by a service terminal of the accommodation facility from the service terminal, and returns a result of the processing to the service terminal.

### Supplementary Note C1

An accommodation support method executed by a computer, the method including:
specifying reservation information of a user by identity authentication of the user in an accommodation facility;
performing check-in processing for the user based on the reservation information;
registering a card ID recorded in a card key, used to unlock a room where the user completing the check-in processing stays and service information regarding a service included in the reservation information in association with each other; and
performing processing according to the service information associated with the card ID if a request including the card ID read from the card key is acquired.

### Supplementary Note D1

A non-transitory computer-readable medium storing an accommodation support program for causing a computer to execute:
specification processing of specifying reservation information of a user by identity authentication of the user in an accommodation facility;
check-in processing for the user based on the reservation information;
registration processing of registering a card ID recorded in a card key, used to unlock a room where the user completing the check-in processing stays and service information regarding a service included in the reservation information in association with each other; and
service processing of performing processing according to the service information associated with the card ID if a request including the card ID read from the card key is acquired.

Although the present invention has been described with reference to the example embodiments (and examples), the present invention is not limited to the above example embodiments (and examples). Various modified examples that can be understood by those skilled in the art can be made to the configuration and details of the present invention within the scope of the present invention.

### REFERENCE SIGNS LIST

1 ACCOMMODATION SUPPORT APPARATUS
11 SPECIFICATION UNIT
12 CHECK-IN UNIT
13 REGISTRATION UNIT
14 SERVICE PROCESSING UNIT
1000 ACCOMMODATION SUPPORT SYSTEM
N NETWORK
U USER
U0 USER
U1 USER
U2 USER
U3 USER
100 USER TERMINAL
200 AUTHENTICATION APPARATUS
210 FACE INFORMATION DB
211 USERID
212 FACE FEATURE INFORMATION
220 FACE DETECTION UNIT
230 FEATURE POINT EXTRACTION UNIT
240 REGISTRATION UNIT
250 AUTHENTICATION UNIT
300 ACCOMMODATION SUPPORT APPARATUS
310 STORAGE UNIT
311 PROGRAM
312 RESERVATION INFORMATION
3121 USER ID
3122 ACCOMMODATION PLAN
3151 ACCOMMODATION PERIOD
3152 ROOM INFORMATION
3153 MEAL INFORMATION
3154 NUMBER OF PERSONS
3155 CHARGE
313 CHECK-IN MANAGEMENT INFORMATION
3131 USER ID
3132 CARD ID
3133 ROOM NUMBER
3134 SERVICE INFORMATION
3161 SERVICE ID
3162 AVAILABLE TIME ZONE
3163 SERVICE CONTENT
320 MEMORY
330 COMMUNICATION UNIT
340 CONTROL UNIT
341 REGISTRATION UNIT
342 AUTHENTICATION CONTROL UNIT
343 SPECIFICATION UNIT
344 CHECK-IN PROCESSING UNIT
345 SERVICE PROCESSING UNIT
4 ACCOMMODATION FACILITY
41 LOBBY
411 CHECK-IN TERMINAL
42 ROOM
42-1 ROOM
42-2 ROOM
421 AUTHENTICATION TERMINAL
421-1 AUTHENTICATION TERMINAL
421-2 AUTHENTICATION TERMINAL
43 RESTAURANT
431 SERVICE TERMINAL
51 CARD KEY
511 CARD ID
52 CARD KEY
521 CARD ID
53 CARD KEY
531 CARD ID
71 CARD KEY ISSUANCE SUPPORT SCREEN
711 SUPPORT MESSAGE
712 SUPPORT IMAGE
72 REGISTERED CONTENT DISPLAY SCREEN
721 SUPPORT MESSAGE
722 SUPPORT IMAGE
723 ROOM NUMBER AND MEAL TICKET INFORMATION
724 SUPPORT MESSAGE
725 REGISTERED CONTENT
73 MEAL TICKET CONFIRMATION SCREEN
731 SUPPORT MESSAGE
732 SUPPORT IMAGE
733 ROOM NUMBER AND MEAL TICKET INFORMATION
734 MENU DISPLAY FIELD
735 TABLE GUIDE DIAGRAM
74 REGISTERED CONTENT DISPLAY SCREEN
741 SUPPORT MESSAGE
743 ROOM NUMBER AND MEAL TICKET INFORMATION
744 SUPPORT MESSAGE
745 REGISTERED CONTENT

What is claimed is:

1. An accommodation support apparatus comprising:
at least one memory configured to store instructions; and
at least one processor configured to execute the instructions to:
specify reservation information of a user by identity authentication of the user in an accommodation facility;
perform check-in processing for the user based on the reservation information;
register a card ID recorded in a card key, used to unlock a room where the user completing the check-in processing stays and service information regarding a service included in the reservation information in association with each other; and
perform processing according to the service information associated with the card ID if a request including the card ID read from the card key is acquired.

2. The accommodation support apparatus according to claim 1, wherein the at least one processor is further configured to:
receive a request including the card ID read from the card key by a service terminal of the accommodation facility from the service terminal; and
return a result of the processing to the service terminal.

3. The accommodation support apparatus according to claim 2, wherein the at least one processor is further configured to:
specify the service information associated with the card ID included in the request; and
return the result of the processing including the specified service information to the service terminal.

4. The accommodation support apparatus according to claim 3, wherein the service information includes an available time zone of a dining room of the accommodation facility.

5. The accommodation support apparatus according to claim 4, wherein the at least one processor is further configured to:
determine availability of entry to the dining room based on the available time zone included in the service information associated with the card ID; and
return a determination result to the service terminal.

6. The accommodation support apparatus according to claim 1, wherein the at least one processor is further configured to:
register entry permission with respect to the dining room of the accommodation facility as the service information if the reservation information includes a food and drink service; and
determine to permit entry to the dining room if the service information associated with the card ID includes the entry permission.

7. The accommodation support apparatus according to claim 1, wherein the service information includes meal content provided in a dining room of the accommodation facility.

8. The accommodation support apparatus according to claim 7, wherein the at least one processor is further configured to:
specify meal content included in the service information associated with the card ID; and
perform processing according to the specified meal content.

9. The accommodation support apparatus according to claim 1, wherein the at least one processor is further configured to:
receive a reference request including the card ID read from the card key by a predetermined authentication terminal and identity authentication information acquired from a holder of the card key,
specify the service information and the reservation information associated with the card ID included in the reference request if identity authentication of the holder using the identity authentication information is successful, and
return the specified service information and reservation information to the authentication terminal.

10-11. (canceled)

12. An accommodation support method executed by a computer, the method comprising:
specifying reservation information of a user by identity authentication of the user in an accommodation facility;
performing check-in processing for the user based on the reservation information;
registering a card ID recorded in a card key, used to unlock a room where the user completing the check-in processing stays and service information regarding a service included in the reservation information in association with each other; and
performing processing according to the service information associated with the card ID if a request including the card ID read from the card key is acquired.

13. A non-transitory computer-readable medium storing an accommodation support program for causing a computer to execute:
specification processing of specifying reservation information of a user by identity authentication of the user in an accommodation facility;
check-in processing for the user based on the reservation information;
registration processing of registering a card ID recorded in a card key, used to unlock a room where the user completing the check-in processing stays and service information regarding a service included in the reservation information in association with each other; and
service processing of performing processing according to the service information associated with the card ID if a request including the card ID read from the card key is acquired.
